(19) United States
(12) Patent Application Publication
(10) Pub. No.: US 2012/0205365 A1
(43) Pub. Date: Aug. 16, 2012

(54) COOK TOP COMPRISING AT LEAST TWO HEATING ELEMENTS AND A POWER ELECTRONICS ARRANGEMENT

(75) Inventors: Daniel Anton Falcon, Zaragoza (ES); Jose Ignacio Artigas Maestre, Zaragoza (ES); Luis Angel Barragan Perez, Zaragoza (ES); Carlos Bernal Ruiz, La Puebla de Alfinden (ES); José Miguel Burdio Pinilla, Zaragoza (ES); Claudio Carretero Chamarro, Zaragoza (ES); Jose Maria De la Cuerda Ortin, Zaragoza (ES); Jose-Ramon Garcia Jimenez, Zaragoza (ES); Pablo Jesus Hernandez Blasco, Cuarte de Huerva (Zaragoza) (ES); Oscar Jimenez Navascues, Cintruenigo (ES); Sergio Llorente Gil, Zaragoza (ES); Oscar Lucia Gil, Zaragoza (ES); Arturo Mediano Heredia, Zaragoza (ES); Ignacio Millan Serrano, Zaragoza (ES); Fernando Monterde Aznar, Zaragoza (ES); Daniel Moros Sanz, Zaragoza (ES); Denis Navarro Tabernero, Zuera (Zaragoza) (ES); Jose Joaquin Paricio Azcona, Zaragoza (ES); Diego Puyal Puente, Zaragoza (ES); Isidro Urriza Parroque, Zaragoza (ES)

(73) Assignee: BSH BOSCH UND SIEMENS HAUSGERÄTE GMBH, Munich (DE)

(21) Appl. No.: 13/503,384

(22) PCT Filed: Oct. 19, 2010
(86) PCT No.: PCT/IB10/54723

§ 371 Date: Apr. 23, 2012

(30) Foreign Application Priority Data
Oct. 26, 2009 (ES) P200930899

(51) Int. Cl. H05B 3/02; H05B 6/12

(52) U.S. Cl. 219/620; 219/507

(57) ABSTRACT

A cook top with at least two heating elements includes a power electronics arrangement connected to a domestic single phase AC supply. The power electronics arrangement includes several power supply units, which each supply heating currents to one or more heating elements, and a switch arrangement with several electromechanical relays for connecting/disconnecting the power supply units to/from the heating elements. Output poles of at least two electromechanical relays associated with different power supply units are connected in parallel, wherein the parallel connection is permanently connected to at least one of the heating elements. This arrangement reduces the number of switching processes required for alternating use of a power supply device with several heating elements, and simplifies compliance with electromagnetic compatibility standards.

The invention relates to a cook top comprising at least two heating elements and a power electronics arrangement as claimed in the preamble to claim 1.

EP 0 986 287 B1 and EP 0 971 562 B1 disclose cook tops having a plurality of heating elements and a power electronics arrangement for connecting the cook top to one or more phases of a domestic AC supply. It is normal to use separate power electronics arrangements, each with a filter and a rectifier, for each phase of a domestic AC supply. Cook tops which are only connected to one phase of the domestic AC supply are generally of inexpensive and simple design and, because of the power limitation of the domestic AC supply, typically have a limited heat output of max. 4.6 kW.

On the other hand, there is a trend toward equipping cook tops with a large number of heating elements which can be used flexibly and can be turned on or off depending on the size and/or position of a cooking utensil placed on the cook top. In such cook tops, power supply units that can be operated independently of one another are installed which are used at any one time to heat a cooking utensil and can be flexibly connected via a switch arrangement to the heating elements assigned to the respective cooking utensil. To implement such switch arrangements, it is known to use electromechanical relays which can make or break a connection between the power supply units and the heating elements.

Switch arrangements of this kind generally interconnect a large number of heating elements, e.g. small inductors of a matrix cook top, to a much smaller number of power supply units, e.g. inverters. The switch arrangement therefore branches out in the direction of the heating elements and, as a rule, each heating element is assigned to the end of a limb of the branching tree structure. Each of the heating elements can therefore be connected to a power supply unit in just one way. Exceptions to this rule can be found in cook tops having what is known as booster mode in which two power supply units can be interconnected to operate a single heating element. A corresponding electromechanical relay opens or closes a link between the two power supply units, in particular between two inverters of an induction cook top. As the heating power in booster mode is to be concentrated onto just one heating element, an additional switch which can disconnect from the power supply the heating elements that are not to be heated is disposed between this switched link and the heating elements in each case.

In order to open up potential cost savings, it is important to be able to use the available resources flexibly for different heating elements. It should be noted here that, in the case of a cook top with a large number of heating elements, it is unlikely that all the heating elements will be used simultaneously and that even if all the heating zones or heating elements are in use, it is only in the rarest of cases that each of the heating elements will need to be operated at full power.

The object of the invention is therefore to make the assignment between power supply units and heating elements more flexible, to reduce the number of switching operations necessary for the alternating use of a power supply unit for a plurality of heating elements, and to facilitate compliance with electromagnetic compatibility standards. The object of the invention is also to allow emergency operation of the cook top even if one of the switches in the switch arrangement becomes inoperable as the result of a defect.

This object is achieved in particular by a cook top having the features set forth in claim 1. Further advantageous embodiments of the invention will emerge from the sub-claims.

The invention relates in particular to a cook top comprising at least two heating elements and a power electronics arrangement for connection to a phase of a domestic AC supply. The power electronics arrangement comprises a plurality of power supply units each supplying one or more heating elements with heating current. The cook top additionally comprises a switch arrangement with a plurality of electromechanical relays for connecting and/or disconnecting the power supply units to/from the heating elements.

The invention relates in particular to cook tops having at least three heating zones i.e. at least three heating elements which are supplied from a single phase of the domestic AC supply and which are disposed, for example, under a cover plate measuring 60 by 80 cm.

It is proposed that at least one of the heating elements is permanently connected to one of at least two output poles of at least two of the electromechanical relays in each case. As a result, a redundant switch arrangement is implemented in which the heating element can be optionally supplied with heating current via two different paths, each of the paths comprising one of the two relays. The number of switching options and the number of possible assignments between power supply units and heating elements is considerably increased, thereby increasing the flexibility of the cook top.

Because of the short response times of induction cook tops compared to radiant cook tops, induction cook tops are particularly suitable for time division multiplex operation. The advantages of the invention are therefore particularly applicable to induction cook tops. In this case, the heating elements are inductors and the power supply units comprise an inverter which can generate a high-frequency heating current from the rectified and possibly filtered current from the domestic AC supply. The frequencies of heating currents in induction cook tops are typically between 20 and 100 kHz.

As the distribution of the available energy to the heating elements or heating zones can be simplified by the invention, a satisfactory result can also be achieved using a lower nominal output of the power electronics arrangement. In particular, the sum of the nominal outputs of the heating elements can be selected greater than the nominal output of the power electronics arrangement. The nominal output of the power electronics arrangement is generally just below the maximum available power of a phase of the domestic AC supply and can be, for example, 4.6 kW for Germany. The maximum power drawn by the power electronics can also be made settable as a function of the available power. This setting can also be performed in combination with other national settings, e.g. a time zone and/or language.

It is further proposed that in the unenergized i.e. normally closed (NC) state of the two relays just one of the two relays connects the heating element to one of the power supply units, while the other relay opens the connection to the same power supply unit or another power supply unit. As a result, operation of the heating element can be implemented even if the switching currents are unavailable because of a defect.

It is additionally proposed that one of the heating elements is permanently connected to one of at least two output poles of at least two of the electromechanical relays. The redundant power supply can therefore be implemented for each of the heating elements. Alternatively, one or more heating elements can be connected to one of at least two output poles of only a single electromagnetic relay.

Potential cost savings can be achieved by sharing of hardware if the power electronics arrangement comprises a common low-pass filter and rectifier for all the power supply units.

In particular, single-pole double-throw switches can be used as electromechanical relays, wherein the two output poles can be connected to different heating elements. In this case it is further proposed that a common center terminal of the relay is connected to a power supply unit and the two output poles of the relay to a heating element in each case, i.e. are disposed between the heating element and the power supply unit in the corresponding direction.

Further increased flexibility of the switch arrangement can be implemented by a plurality of series-connected relays in a connection between a power supply unit and a heating element. The switch arrangement can in particular comprise a plurality of branching layers.

The number of branching layers, i.e. the number of relays connected in series, can also be made different for different heating elements. For example, it may be advisable to configure the switch arrangement such that centrally disposed heating elements can be connected to a particularly large number of power supply units i.e. inverters, while heating elements disposed at the edge of the cook top can be connected to a smaller number of power supply units. This enables the centrally disposed heating elements to be very flexibly combined with other heating elements to form heating zones, which is not required to the same extent for heating elements disposed at the edge of the heating zone.

Further advantages will emerge from the following description of the drawings which depict exemplary embodiments of the invention. The drawings, the description and the claims contain numerous features in combination. The average person skilled in the art will also expediently consider the features individually and integrate them to produce further useful combinations.

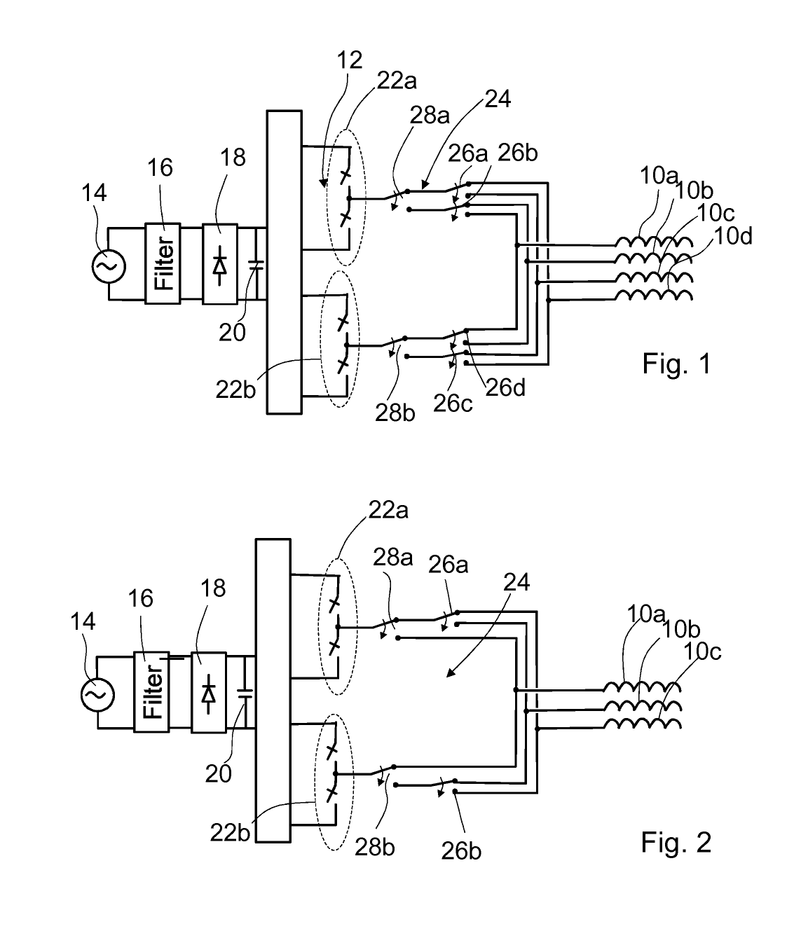

FIG. 1 schematically illustrates the design of a cook top having a plurality of heating elements and a power electronics arrangement for connection to an individual phase of a domestic AC supply,

FIG. 2 schematically illustrates the design of a cook top according to an alternative embodiment of the invention,

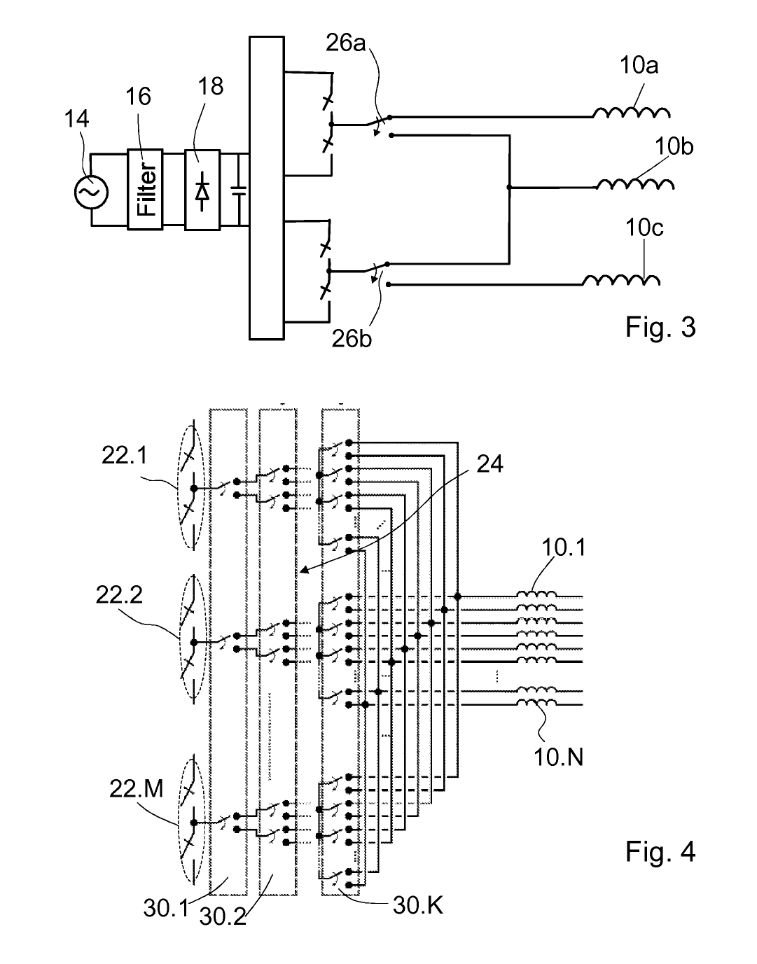

FIG. 3 schematically illustrates the design of a cook top according to an another alternative embodiment of the invention, and

FIG. 4 schematically illustrates the design of a cook top in a generalization of the inventive concept.

FIG. 1 schematically illustrates a cook top comprising four heating elements 10a-10d and a power electronics arrangement 12. The power electronics arrangement is used to connect the cook top to a single phase 14 of a domestic AC supply and powers the entire cook top from the current of said phase 14.

The power electronics arrangement comprises a filter 16 and a rectifier 18 which filter the alternating current from the domestic supply and convert it into direct current which undergoes further filtering by a damping capacitor 20. The filter 16 is a low-pass filter which prevents cook top damage caused by powerful pulses from the domestic AC supply as well as flicker-intensifying feedback from the cook top into the AC supply.

In the example shown in FIG. 1, the power electronics module additionally comprises two power supply units 22a,22b which are implemented as inverters and are operated by a control unit (not shown here) such that a heating current with a desired heating frequency is produced. The two inverters 22a,22b can generate heating currents with different heating frequencies, different amplitudes and/or different load cycles or rather phases in order to produce the desired heating power in the heating elements 10a-10d. The heating elements 10a-10d are inductors which generate a high-frequency magnetic field at the frequency of the heating current. The magnetic field induces eddy currents in a ferromagnetic base of a cooking vessel placed on the cook top in the region of the heating element 10a-10d in question, thereby directly heating said vessel.

Disposed between the power supply units 22a,22b and the heating elements 10a-10d is a switch arrangement 24 comprising electromechanical relays 26a-26d. The relays 26a-26d are single-pole double-throw switches whose common central terminal is connected to a pole of two other relays 28a,28b in each case. The other relays 28a, 28b are each connected via their central terminal to a power supply unit 22a, 22b. By appropriate switching of the relays 26a,26b,28a-28d, each of the power supply units 22a, 22b can be connected to each of the heating elements 10a-10d. The heating elements 10a-10d are in turn permanently connected in each case to two output poles of two different relays 26a-26d of the second layer of relays of the switch arrangement 24. As a result, each of the heating elements 10a-10d can be simultaneously connected to both power supply units 22a,22b in order to concentrate the total available energy on the heating element 10a-10d in question. In this case, the two power supply units 22a,22b implemented as inverters must generate heating currents of the same heating frequency in order to prevent destructive interference.

The output poles of the relays 26a-26d to which one of the heating elements 10a-10d is connected are selected such that, in the unenergized state of the relays 26a-26d just one of the relays connects the heating element 10a-10d to one of the power supply units 22a,22b, while the other relay 26a-26d breaks the connection to the other power supply unit 22a,22b. The heating element 10a is therefore, for example, connected to the normally closed (NC) output pole of the relay 26b and to the normally open (NO) output pole of the relay 26c.

The sum of the nominal outputs of the heating elements 10a-10d is greater than the nominal output of the power electronics arrangement 12, i.e. of the phase 14 of the domestic AC supply. For example, the sum of the nominal outputs of the heating elements 10a-10d can be 7.2 kW and the nominal output of the power electronics arrangement 4.6 kW.

By means of the two-layer design of the switch arrangement 24 shown in FIG. 1, two series connected relays 28a,28b,26a-26d are disposed in the connections between the heating elements 10a-10d and the power supply units 22a,22b in each case.

FIG. 2 shows another exemplary embodiment of the invention. In order to avoid repetitions, the following description will essentially confine itself to differences compared to the exemplary embodiment shown in FIG. 1, reference being made to FIG. 1 in respect of features that remain unchanged.

In the exemplary embodiment shown in FIG. 2, the cook top comprises three heating elements 10a-10c and the switch arrangement 24 comprises only four relays 28a,28b,26a,26b in total. The heating element 10a is only connected to the power supply units 22a,22b via one relay 28a,28b in each case, while the heating elements 10b, 10c are each connected to the power supply units 22a,22b via two series connected relays 26a, 28a and 26b, 28b respectively.

FIG. 3 shows another alternative exemplary embodiment of the invention comprising only two relays 26a, 26b and three heating elements 10a, 10b, 10c. Of the heating elements, only the middle heating element 10b is connected to output poles of the two relays 26a,26b, while the heating elements 10a are connected to the output pole of only one relay 26a,26b in each case.

FIG. 4 shows a generalization of the design of an inventive induction cook top having M power supply units 22.1-22.M, or more specifically inverters, and N heating elements 10.1-10.N which are connected to the power supply units 22.1-22.M via a switch arrangement 24, where M<N. The number K of branching layers 30.1-30.K of the arrangement 24 is at least as great as the largest integer which is greater than the binary logarithm from the number of power supply units M.

The switch arrangement 24 can be mounted on a separate circuit board or together with the power supply units 22.1-22.M on a single circuit board. The same applies to the low-pass filter 16 and the rectifier 18. These elements can also be mounted on a separate circuit board or together with the power supply units 22.1-22.M on a large circuit board.

The invention can be used both for traditional layouts with four permanently predefined heating zones and for matrix cook tops with a large number of heating elements which are disposed in a grid and can be flexibly combined for heating a single cooking vessel. The topology in FIG. 3 is particularly suitable for layouts with so-called paella heating zones in which a large heating zone for heating a paella pan can be produced in the middle of the cook top using the central heating element 10b.

### REFERENCE CHARACTERS

10 heating element
12 power electronics arrangement
14 phase
16 filter
18 rectifier
20 damping capacitor
22 power supply unit
24 switch arrangement
26 relay
28 relay
30 branching layer

1-11. (canceled)

12. A cook top, comprising:
at least two heating elements,
a power electronics arrangement having an input connected to a single phase of a domestic AC supply, said power electronics arrangement comprising a plurality of power supply units, each power supply unit supplying one or more of the at least two heating elements with heating currents, and
a switch arrangement comprising a plurality of electromechanical relays for connecting the power supply units to and/or disconnecting the power supply units from the heating elements,
wherein output poles of at least two electromechanical relays associated with different power supply units are connected in parallel, said parallel connection permanently connected to at least one of the heating elements.

13. The cook top of claim 12, wherein the heating elements are inductors and each of the plurality of power supply units comprises an inverter.

14. The cook top of claim 12, wherein the sum of nominal power rating of the heating elements in greater than a nominal power rating of the power electronics arrangement.

15. The cook top of claim 12, wherein in an unenergized state of the at least two relays, exactly one of the at least two relays connects the heating element to one of the power supply units, while others of the at least two relays disconnect the heating element from other power supply units.

16. The cook top of claim 12, wherein output poles of at least two of the electromechanical relays are connected in parallel, and wherein each of the heating elements is permanently connected to the parallel-connected output poles.

17. The cook top of claim 12, wherein at least one of the heating elements is connected to one of at least two output poles of a single electromechanical relay.

18. The cook top of claim 12, wherein the power electronics arrangement comprises a low-pass filter and a rectifier which are shared by all power supply units.

19. The cook top of claim 12, wherein the at least two electromechanical relays are single-pole double-throw switches.

20. The cook top of claim 19, wherein a single-pole double-throw switch has a common central terminal connected to a power supply unit and two output poles, with each output pole connected to a different heating element.

21. The cook top of claim 12, wherein the switch arrangement comprises a plurality of series-connected relays, with the series connection connected between a power supply unit and a heating element.

22. The cook top of claim 21, wherein a number of series-connected relays disposed between at least one first heating element and a power supply unit is different from a number of series-connected relays disposed between at least one second heating element and a power supply unit.
